(19) United States
(12) Patent Application Publication
(10) Pub. No.: US 2025/0223449 A1
(43) Pub. Date: Jul. 10, 2025

(54) COATINGS

(71) Applicant: JOTUN A/S, Sandefjord (NO)

(72) Inventors: Anders SOLLI, Sandefjord (NO); Thor Andre KARLSEN, Skien (NO)

(21) Appl. No.: 18/854,634

(22) PCT Filed: Apr. 5, 2023
(86) PCT No.: PCT/EP2023/058955

§ 371 Date: Oct. 7, 2024

(30) Foreign Application Priority Data
Apr. 7, 2022 (EP) 22167237.1

(51) Int. Cl. C09D 5/08; C08G 59/24; C08G 59/50; C08K 5/5435; C08K 7/28; C09D 7/20; C09D 7/40; C09D 7/61; C09D 163/00

(52) U.S. Cl. CPC C09D 5/08; C08G 59/245; C08G 59/5026; C08G 59/5033; C09D 7/20; C09D 7/61; C09D 7/69; C09D 7/70; C09D 163/00; C08K 5/5435; C08K 7/28

(57) ABSTRACT

A primer coating composition comprising: (i) an epoxy resin; (ii) 2.0 to 15 wt % of silane; (iii) a curing agent; (iv) a glycol ether solvent; and (v) 1.0 to 9.0 wt % microspheres.

This invention relates to a primer coating composition that can be applied on damp, moist, wet or rusted substrates to provide an anti-corrosive primer layer on the substrate. The invention requires the combination of an epoxy resin, a silane, microspheres and a glycol ether solvent.

### BACKGROUND OF INVENTION

Before application of a primer, it is often necessary to properly prepare the surface to achieve a proper roughness and cleanliness. This is usually achieved by cleaning and sandblasting. If the roughness and cleanliness is insufficient, the anticorrosive primer cannot be expected to provide long term protection of the substrate.

For poorly prepared surfaces it is necessary to have coatings that are more surface tolerant than the common epoxy primers. Mastic type epoxy primers have been found to be suitable for poorly prepared substrates. There is however one problem that remains to be solved: application of coatings on moist or wet substrates or on rusted substrates, especially flash rusted surfaces.

The importance of solving this problem has increased in recent years with the emergence of surface preparation by ultra-high pressure water jetting (UHPWJ) instead of the traditional sand blasting. When the substrate is water jetted, the steel surface profile is not roughened and residues of old paint may still remain on the substrate. Residual water is also left on the surface, and for time saving purposes as well as for minimizing the amount of flash rust that is formed, it is preferred if the surface can be coated before it dries. In hot climates, drying may occur rapidly but the result may be flash rust on the surface. It would be beneficial to provide a coating composition that will adhere to moist or wet substrates, on flash rusted substrates and on substrates that have residues of old paint.

Due to the residual water on the substrate and the flash rust that forms on wet steel, application of an anticorrosive primer on UHPWJ substrates is a challenge. A coating composition that is suitable for application on moist and wet substrates and which is also tolerant to residues of old paint is therefore beneficial. It is also advantageous to have a coating composition with a high volume solids ratio (low content of volatile organic compounds (VOC)), low density, low viscosity for good application properties, and a long pot life, in addition to excellent anticorrosive properties.

For moist and wet surface tolerance, ketimine or aldimine based curing agents are commonly used. Ketimines and aldimines are hydrolysed in the presence of water to provide the free amines and a ketone or an aldehyde. The liberated amine reacts with the epoxy functional resin and the ketone or aldehyde preferably evaporates out of the coating film. This makes ketimines and aldimines suitable for use on moist and wet substrates. A disadvantage of using ketimines and aldimines is the release of ketones and aldehydes which are VOCs and have negative health and safety impacts.

In addition, if a high wet film thickness is applied the release of the ketone or aldehyde is hindered by the thick film which can lead to entrapped volatile components. Furthermore, as ketimines and aldimines are hydrolytically unstable there may be challenges associated with their production and storage. Also, as ketimines and aldimines need to hydrolyse to form the free amine, a certain amount of moisture is required. Hence, if a ketimine or aldimine cured product is applied in too dry conditions, very slow cure would result.

JP2021143270 describes an anticorrosive coating for marine structures that can be applied on wet substrates. This coating composition comprises a specific polyamine curing agent to provide a coating composition that can be applied on wet surfaces.

JP6629540 describes an anticorrosive coating composition that can be applied to wet surfaces. A polyoxyalkylene polyamine, Mannich modified amine or ketimine curing agent is used to provide a coating that can be applied on wet surfaces.

JP6629539 describes a coating composition that can be applied on deteriorated paint without any pre-treatment except water washing. JP6629539 also achieves this by using a polyoxyalkylene polyamine, Mannich modified amine or ketimine curing agent.

WO 2020/253732 describes a coating composition that is capable of insulating steel from LNG spills. WO 2020/253732 achieves this by using a low density filler and a Jeffamine curing agent.

WO2012/035520 describes an anti-impact multilayer coating based on a epoxy resin, microspheres and amine or isocyanate curing agent. The importance of the silane and glycol ether are not highlighted.

US2020/017711 describes a curable composition comprising a binder and polysiloxane resin for footwear. The use of a polyurethane binder is preferred.

CN106024946 describes a solar cell backing layer. The pattern layer comprises a first host resin, the intermediate layer comprises a second host resin and the weathering layer comprises a fluorine resin.

US2007/048445 describes a sound dampening coating for a vehicle. The example uses an epoxy resin.

WO2020/065588 describes a composition comprising amino-functional silanes and a photoluminescent compound.

The present inventors have now devised a primer coating composition which is tolerant towards flash rust and wet or moist substrates, i.e. the primer layer composition of the invention can be applied to a wet or rusted substrate and it adheres thereto. The coating composition of the present invention also has good application properties, long pot-life and good anti-corrosive properties. Without wishing to be bound by theory, we surmise that these effects are linked to the particular solvent used in the coating composition along with the defined levels of silane and microspheres.

### SUMMARY OF INVENTION

Thus, viewed from one aspect the invention provides a primer coating composition comprising:
(i) an epoxy resin;
(ii) 2.0 to 15 wt % of silane;
(iii) a curing agent;
(iv) a glycol ether solvent; and
(v) 1.0 to 9.0 wt % microspheres.

In any embodiment of the invention it is preferred if the glycol ether solvent is of formula (I):

R—[O—R′]ₓ—OH (I)
wherein x is 1 to 3;
R is a C₁-C₁₆ aliphatic group; and
R′ is a C₁-C₁₆ aliphatic group.

Viewed from one aspect the invention provides a primer coating composition comprising:
(i) an epoxy resin;
(ii) 2.0 to 15 wt % of silane;
(iii) a curing agent;
(iv) a glycol ether solvent;
(v) 1.0 to 9.0 wt % microspheres; and
(vi) hydrocarbon resin.

Viewed from one aspect the invention provides a primer coating composition comprising:
(i) an epoxy resin;
(ii) 2.0 to 15 wt % of silane;
(iii) a curing agent;
(iv) a glycol ether solvent;
(v) 1.0 to 9.0 wt % microspheres; and
(vi) reactive diluent.

Viewed from one aspect the invention provides a primer coating composition comprising:
(i) an epoxy resin;
(ii) 2.0 to 15 wt % of silane;
(iii) a curing agent;
(iv) a glycol ether solvent;
(v) 1.0 to 9.0 wt % microspheres;
(vi) a hydrocarbon resin; and
(vii) reactive diluent.

Viewed from another aspect the invention provides a kit suitable for the preparation of a primer coating composition of the invention comprising:
a component (A) comprising an epoxy resin; and
a component (B) comprising a curing agent;
wherein at least one of components (A) or (B) comprises a silane, a glycol ether solvent and microspheres;
such that when components (A) and (B) are combined, the resulting primer layer composition comprises 2.0 to 15 wt % of the silane and 1.0 to 9.0 wt % of the microspheres.

Viewed from another aspect the invention provides a metal substrate coated with a primer coating composition as hereinbefore defined.

Viewed from another aspect the invention provides a metal substrate with a primer coating composition as hereinbefore defined which has been cured.

Viewed form another aspect the invention provides a process for the preparation of a primer coating composition as hereinbefore defined comprising blending components (A) and (B)
wherein component (A) comprises an epoxy resin; and
component (B) comprising a curing agent;
wherein at least one of components (A) or (B) comprises a silane; a glycol ether solvent and microspheres such that when components (A) and (B) are combined, the resulting primer layer composition comprises 2.0 to 15 wt % of the silane and 1.0 to 9.0 wt % of the microspheres.

Viewed from another aspect the invention provides a process for the application of a primer coating composition to a substrate comprising blending components (A) and (B)
wherein component (A) comprises an epoxy resin; and
component (B) comprising a curing agent;
wherein at least one of components (A) or (B) comprises a silane; a glycol ether solvent and microspheres such that when components (A) and (B) are combined, the resulting primer layer composition comprises 2.0 to 15 wt % of the silane and 1.0 to 9.0 wt % of the microspheres; to form a primer layer composition;
applying said composition to a substrate, e.g. by airless spraying and optionally allowing said coating to cure. That substrate is ideally one that is moist and/or rusted.

Viewed from another aspect the invention provides a method for painting on a wet metal substrate comprising
1) blending component A and component B;
wherein component (A) comprises an epoxy resin; and
component (B) comprising a curing agent; and wherein at least one of components (A) or (B) comprises a silane; a glycol ether solvent and microspheres such that when components (A) and (B) are combined, the resulting composition comprises 2.0 to 15 wt % of the silane and 1.0 to 9.0 wt % of the microspheres;
2) applying the composition to a wet substrate and
3) allowing said composition to form a film and cure.

Viewed from another aspect the invention provides a kit suitable for the preparation of a primer coating composition as hereinbefore defined comprising a component (A) comprising:
(i) epoxy resin;
(ii) a silane;
(iii) a glycol ether solvent; and
(iv) microspheres;
and a component (B) comprising at least one curing agent.

Viewed from another aspect the invention provides use of a primer coating composition as herein defined for application to a wet and/or rusted substrate.

In all embodiments it is preferred if the epoxy resin is a liquid.

In all embodiments it is preferred if the solvent comprises propylene glycol n-butyl ether.

In all embodiments it is preferred if the silane is an epoxy silane.

### Definitions

The invention relates to a primer coating composition. The term coating composition is used to define a composition formed from the combination of the first composition (component A) and the second composition (component B). To prevent premature curing, the primer coating composition of the invention is supplied in two parts, a first composition (component A) comprising the epoxy resin and a second composition (component B) comprising the curing agent. The other constituents of the composition are preferably present in component (A) but could also be added via component (B). Weight percentages herein are based on the primer layer composition as a whole. The weight percentages of the constituents within component (A) and (B) can be readily determined based on the weight percentages in the final primer layer composition and the mixing ratio of component (A) and (B).

### DETAILED DESCRIPTION OF INVENTION

This invention relates to a primer coating composition for a substrate such as a metal substrate, especially a steel substrate. The primer coating composition can be applied to a moist, wet or rusted substrate. The substrate might form part of any article that requires a primer coating to be applied, e.g. large metal structures.

The primer coating composition forms an epoxy primer layer on the substrate. That primer layer can be overcoated as desired with topcoats, tiecoats, antifouling coatings and intumescent coatings. The primer coating of the invention may therefore be the only layer applied to the substrate or it can be a layer in a coating system comprising the said primer coating and additional layers. No additional topcoat or overcoating layer is required. However, if the substrate is the outside of the hull of a vessel, it is to be understood that the primer normally will be coated with an antifouling paint, and optionally a tiecoat between the primer layer and the antifouling layer. Further, if the substrate is to be exposed to outdoor conditions (e.g., UV radiation from the sun), it is beneficial to coat the primer with a UV- and weather resistant topcoat. The primer coating provides good anticorrosive protection.

In an embodiment, the primer coating composition may be applied as a single layer or as two or more layers. It may be that two coats of the primer coating composition are applied to the substrate. It is also possible that two different primer coating compositions are applied.

The primer coating composition may also be overcoated with a topcoat. The primer coating composition may also be overcoated with a tiecoat and an antifouling coating layer. The primer coating composition in these embodiments may itself have been applied as a single coat or as two coats.

Suitable systems include:
2 primer coats+top coat.
2 primer coats+tiecoat+antifouling
1 primer coat+top coat.

An overcoat may not be needed if the substrate is not the outside of a ship's hull or if the substrate is not exposed to outdoor conditions (UV-radiation from sunlight). However, to ensure weather- and UV-resistance of the coating system, the primer coating composition is preferably overcoated with a topcoat. If an overcoating layer is present, any known overcoating layer may be used. Note that it is preferred if the coating composition is applied as two coats, i.e. in two application steps. However, the composition may be applied in one coat alone.

### Primer Coating Composition

A particular feature of the primer coating composition of the invention is the high solids content and thereby the low content of volatile organic compounds (VOC) present. The primer layer coating composition preferably has a solids content of at least 70 wt %, such as at least 75 wt %, more preferably at least 80 wt %. The volume solids (expressed in %) is often referred to as “VS %”. VS % is determined according to ASTM D5201-05a (2020). The primer coating composition has a % volume solids of at least 70%, such as at least 75%, preferably at least 80%.

The high solids volume leads to lower VOC content. The VOC content is preferably 220 g/L or less, more preferably 200 g/L or less, even more preferred 180 g/L or less, such as 160 g/L or less. The VOC can be determined theoretically (ASTM D5201-05a (2020)).

The pot life of the primer coating composition of the invention is preferably at least 30 mins, more preferably at least 60 minutes, such as 90 to 120 mins at 23° C. By pot life is meant the time after mixing of the first and second components (A) and (B) when the composition is still able to be applied to the substrate by an airless spray procedure. If the composition cures too rapidly the coating composition has a very short pot life. Pot lives of less than 30 minutes are commercially challenging given the time it takes to coat a large object such as a ship block and the length of hoses up to 150 m feeding the spray gun.

Many of the important properties of the composition of the invention are a consequence of the high solids and yet relative low viscosity of the claimed composition.

The viscosity of the primer coating composition measured just after combination of the two components may be 200 to 1100 mPas, such as 200 to 1000 mPas at 23° C., especially 450 to 800 mPas.

It will be appreciated that the composition cures over time and hence the viscosity of the composition increases during curing. The viscosity quoted is the initial viscosity measured immediately after mixing and hence before any significant degree of the curing process has taken place. By immediately after mixing means within 10 minutes of mixing.

The viscosity of the primer coating composition measured after 60 minutes is ideally less than 2200 mPas, more ideally less than 2000 mPas.

The pigment volume concentration of the primer coating composition of the invention is preferably 30 to 45%, such as 32 to 42%.

### Epoxy Resin

The primer coating composition comprises a binder based on at least one epoxy resin. A mixture of epoxy resins may also be used. If multiple epoxy resins are used then it is the combination of these epoxy resins that form the binder within the primer layer composition.

Shortly before application of the primer layer composition to a substrate, the first composition (component A) comprising the epoxy resin is mixed with a second composition (component B) comprising a curing agent to form the primer layer composition. That primer layer composition is then applied to a substrate and cures to form the primer layer on a substrate.

The binder in the primer layer composition may comprise one or more than one epoxy resins. Ideally, the primer layer composition comprises at least one liquid epoxy resin. The term liquid refers to the state of the epoxy resin at room temperature and pressure 23° C., 1 atm.

The terms epoxy resin or epoxy binder are used interchangeably herein. Preferably the epoxy resin is an aromatic or aliphatic epoxy binder preferably comprising more than one epoxy group per molecule. The epoxy-groups may be in an internal or terminal position on the epoxy binder or on a cyclic structure incorporated into the epoxy binder. Preferably the epoxy based binder comprises at least two epoxy group so that a crosslinked network can be formed.

It should be understood that the epoxy binders of the present invention also encompass binders that have the traditional epoxy backbones but where the epoxy end-groups have been modified with acrylic or methacrylic functional groups that can be cured with the same curing agents as the epoxy-groups.

Suitable aliphatic epoxy-based binders include epoxy and modified epoxy binders selected from cycloaliphatic diglycidyl ethers such as diglycidyl ethers based on hydrogenated bisphenol A, hydrogenated bisphenol F, and dicyclopentadiene based binders, glycidyl ethers such as polyglycidyl ethers of polyhydric alcohols, epoxy functional acrylic resins or any combinations thereof.

Suitable aromatic epoxy-based binders includes epoxy and modified epoxy binders selected from bisphenol type epoxy-based binders such as the diglycidyl ethers of bisphenol A, bisphenol F and bisphenol S, resorcinol diglycidyl ether (RDGE), novolac type epoxy-based binders such as epoxy phenol novolac resins, epoxy cresol novolac resins and bisphenol A epoxy novolac resins, glycidyl ethers of dihydroxynaphtalenes or any combinations thereof.

In one preferred embodiment the epoxy-based binder is an aromatic epoxy-based binder. Preferably, the aromatic epoxy-based binder is derived from a combination of a compound comprising a least one epoxide functionality with an aromatic co-reactant comprising at least two hydroxyl groups.

Preferred epoxy binders are bisphenol epoxy binders. Preferred epoxy-based binders are bisphenol A and bisphenol F epoxy-based binders or bisphenol A/F epoxy binders. In a preferred embodiment the epoxy-based binder is a bisphenol A epoxy-based resin, and most preferably the epoxy-based binder is an unmodified liquid bisphenol A based epoxy resin.

The epoxy-based binder may be a modified epoxy-based binder. Preferably the epoxy-based binder is modified with fatty acids, polypropylene oxide and/or polyethylene oxide, acrylic acids, carboxylic acids or carboxyl terminated butadiene acrylonitrile (CTBN).

The solids content in the epoxy-based binder is preferably more than 70 wt. %, preferably more than 80 wt. %, preferably more than 90, most preferred more than 99 wt. %. In a further preferred embodiment, the epoxy-based binder is solvent free.

Examples of suitable commercially available epoxy-based binders are:
Bisphenol A type epoxy-based binders: D.E.R. 331 and D.E.R. 332 from Olin Epoxy
Bisphenol F epoxy based binders: Epikote 862 from Hexion, D.E.R. 354 from Olin Epoxy.
Mixture of bisphenol A and bisphenol F epoxy based binders: D.E.R. 352 from Olin Epoxy, Epikote 235 from Hexion.

The epoxy-based binder may be either a liquid epoxy-based binder, a semi-solid epoxy binder, or a solid epoxy-based binder or a combination thereof. It should be understood that “liquid” and “solid” refers to the physical state of the epoxy-based binder at ambient temperature and pressure (23° C. and 1 atm). In one preferred embodiment the epoxy-based binder is a liquid epoxy-based binder. In one preferred embodiment the epoxy-based binder is a liquid bisphenol A epoxy resin.

The epoxy-based binder may have an epoxy equivalent weight (EEW) value of 140 to 1000. It is particularly preferred if the EEW is less than 500 such as 150 to 270, especially 160 to 200.

The number of “epoxy equivalents” is the sum of the contribution from each of the one or more epoxy resins and any other component that contains an epoxy such as the silane and reactive diluent. The contribution from each of the one or more epoxy resins to the epoxy equivalents is defined as grams of the epoxy resin divided by the epoxy equivalent weight of the epoxy resin, where the epoxy equivalent weight of the epoxy resin is determined as: grams of the epoxy resin equivalent to 1 mol of epoxy groups. For adducts with epoxy resins the contribution of the reactants before adductation is used for the determination of the number of “epoxy equivalents” in the epoxy-based binder system.

The viscosity of the liquid epoxy-based binder is preferably 1000 to 20 000 mPas, more preferred 2000 to 15 000 mPas. The use of a liquid bisphenol A type epoxy-based binder is most preferred.

If there are liquid, semi-solid and solid epoxy-based binders present in the epoxy-based binder system, it is preferred if the liquid epoxy-based binder is in excess relative to the semi-solid and/or solid epoxy-based binder.

The epoxy resin is preferably present in 5.0 to 40 wt % of the primer coating composition, such as 10 to 40 wt % of the primer coating. More preferably the epoxy resin is present in an amount of 20 to 40 wt %, especially 20 to 30 wt %. If a blend of epoxy resins is used then these percentages refer to the total epoxy resin content, i.e. adding the wt % of each one.

In one preferred embodiment the epoxy-based binders include bisphenol A based binders, such as 4,4′-isopropylidenediphenol-epichlorohydrin resins, bisphenol F based binders and/or novolac based binders. In one preferred embodiment the epoxy-based binder system comprises one or more bisphenol A epoxy-based binders. Bisphenol A epoxy-based binders will be known to those in the field and have the general structure below.

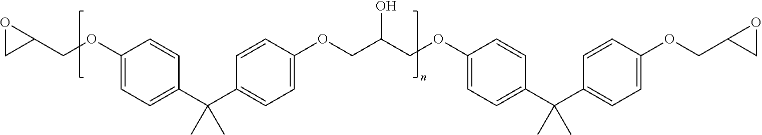

In one embodiment the epoxy-based binder system comprises one or more bisphenol F epoxy-based binders.

The bisphenol F epoxy-based binder may have an EEW value of 100 to 350. However, it is particularly preferred if the EEW is 300 or less such as 100 to 300, especially 150 to 200. Preferably the bisphenol F epoxy-based binder is a liquid.

The Mw of the bisphenol F resin may be more than 300 g/mol. A preferred bipshenol F (4′,4′-methylenebisphenol) epoxy-based binder derives from the combination of bisphenol F and epichlorohydrin. The use of a difunctional epoxy-based bisphenol F binders is especially preferred.

A combination of two or more bisphenol F binders might be used. The viscosity of the bisphenol F binders are preferably 1000 to 10 000 mPas, more preferred 2000 to 5000 mPas.

### Silane

The coating composition of the invention also contains at least one silane. Silanes can improve drying properties at low temperature, flexibility, adhesion to substrates and anti-corrosive performance.

The silane can be provided as part of component A and/or as part of component B, preferably component A. Ideally, the silane is one that contains an epoxy group. Silanes of use in the invention are generally of low Mw such as less than 400 g/mol. Suitable silanes are of general formula (III) or (IV)

Y—R²_{(4-z)}SiX_{z} (III) or

Y—R²_{(3-y)}R¹SiX_{y} (IV)
wherein z is an integer from 1 to 3,
wherein y is an integer from 1 to 2,
R² is a hydrocarbylene group having 1 to 12 C atoms optionally containing an ether or amino linker,
R¹ is a hydrocarbyl group having 1 to 12 C atoms;
Y is a functional group bound to R that can react with corresponding hardener or binder functionalities and is preferably an amine or epoxy group, and
each X independently represents a halogen group or an alkoxy group.

Preference is given to isocyanate, epoxy, glycidyl ether, amino, hydroxy, thiol, carboxy, acrylate, or methacrylate groups as functional groups Y. The Y group can bind to any part of the chain R. It will be appreciated that where Y represents an epoxy group then R will possess at least two carbon atoms to allow formation of the epoxide ring system.

It is especially preferred if Y is an amino group or epoxy group. Amino groups are preferably NH₂. Y is preferably an epoxy group.

If the Y group is epoxy, it is preferred if the silane is provided separately from the amine based curing agent composition, e.g. together with the epoxy binder. In general, in the kit of the invention, the silane should not react with any ingredient of the component of the kit in which the silane is present.

It is especially preferred if X is an alkoxy group such as a C₁₋₆ alkoxy group, especially methoxy or ethoxy group. It is also especially preferred if there are two or three alkoxy groups present. Thus z is ideally 2 or 3, especially 3. Subscript y is preferably 2.

R¹ is preferably C₁₋₄ alkyl such as methyl.

R² is a hydrocarbylene group having up to 12 carbon atoms. By hydrocarbylene is meant a group comprising C and H atoms only. It may comprise an alkylene chain or a combination of an alkylene chain and rings such as phenylene or cyclohexylene rings. The term “optionally containing an ether or amino linker” implies that the carbon chain can be interrupted by a —O— or —NH— group in the chain, e.g. to form a silane such as [3-(2,3-epoxypropoxy)propyl]trimethoxysilane:H₂COCHCH₂OCH₂CH₂CH₂Si(OCH₃)₃. It is preferred if the group Y does not bind to a carbon atom which is bound to such a linker —O— or —NH—.

R² might therefore represent —(C₆H₄)—NH—(CH₂)₃— or (C₆H₄)—(CH₂)₃ and so on.

R² is preferably an unsubstituted (other than Y obviously), unbranched alkylene chain having 2 to 8 C atoms optionally containing an ether or amino linker.

A preferred silane general formula is therefore of structure (V)

Y′—R³_{(4-z′)}SiX′_{z′} (V)
wherein z′ is an integer from 2 to 3, R³ is a unsubstituted, unbranched alkylene chain having 2 to 8 C atoms optionally containing an ether or amino linker, Y′ is an amino or epoxy functional group bound to the R³ group, and X′ represents an alkoxy group.

Examples of such silanes are the many representatives of the products manufactured by Evonik Industries AG and marketed under the brand name of Dynasylan®, the Silquest® silanes manufactured by Momentive, and the GENIOSIL® silanes manufactured by Wacker.

Specific examples include methacryloxypropyltrimethoxysilane (Dynasylan MEMO, Silquest A-174NT), 3-mercaptopropyltri(m)ethoxysilane (Dynasylan MTMO or 3201; Silquest A-189), (3-glycidoxypropyl)trimethoxysilane (Dynasylan GLYMO, Silquest A-187), (3-glycidoxypropyl)triethoxysilane (Dynasylan GLYEO), tris(3-trimethoxysilylpropyl) isocyanurate (Silquest Y11597), beta-(3,4-epoxycyclohexyl)ethyltrimethoxysilane (Silquest A-186), gamma-isocyanatopropyltrimethoxysilane (Silquest A-Link 35, Geniosil GF40), (methacryloxymethyl)trimethoxysilane (Geniosil XL 33), isocyanatomethyl)trimethoxysilane (Geniosil XL 43), (3-aminopropyl)trimethoxysilane (Dynasylan AMMO; Silquest A-1110), (3-aminopropyl)triethoxysilane (Dynasylan AMEO) or N-(2-aminoethyl)-3-aminopropyltrimethoxysilane (Dynasylan DAMO, Silquest A-1120) or N-(2-aminoethyl)-3-aminopropyltriethoxysilane, triamino-functional 3-[2-(2-aminoethylamino)ethylamino]propyltrimethoxysilane (Silquest A-1130), bis[3-(trimethoxysilyl) propyl]amine (Silquest A-1170), N-ethyl-3-trimethoxysilyl-2-methylpropanamine (Silquest A-Link 15), N-phenyl-3-aminopropyltrimethoxysilane (Silquest Y-9669), 4-amino-3,3-dimethylbutyltrimethoxysilane (Silquest Y-11637), (N-cyclohexylaminomethyl)triethoxysilane (Geniosil XL 926), (N-phenylaminomethyl)trimethoxysilane (Geniosil XL 973), Deolink Epoxy TE and Deolink Amino TE (D.O.G Deutsche Oelfabrik) and mixtures thereof. The oligomeric epoxysilane, Coatosil MP 200 from Momentive may also be used in the composition.

Specific silanes of interest include (3-glycidoxypropyl)triethoxysilane (H₂COCHCH₂OCH₂CH₂CH₂Si(OCH₂CH₃)₃, (3-glycidoxypropyl)trimethoxysilane (H₂COCHCH₂OCH₂CH₂CH₂Si(OCH₃)₃).

The use of silane (3-glycidoxypropyl)trimthoxysilane is especially preferred. A mixture of silanes might also be used.

The amount of silane present in the primer layer composition may be 2.0 to 15 wt %, preferably 2.5 to 10 wt %, more preferably 2.5 to 8.0 wt % on total weight, ideally 3.0 to 7.0 wt %. If a blend of silanes is used then these percentages refer to the total silane content.

Using the silane in this amount ensures therefore that the primer layer composition of the invention adheres to the substrate below even when the substrate is wet or rusted on application of the composition. If the content of silane is below 2.0 wt % in the primer layer composition then adhesion failure occurs when applying the composition to the target substrates.

### Curing Agent

The primer coating composition of the invention comprises at least one curing agent. Ideally it is amine based and is not modified in any way to increase its compatibility with water. That is, no hydrophilic structural segments like polyether segments are present in the molecular structure of the curing agent. Curing agents are preferably selected from N-benzylated polyalkyleneamines, amine-epoxy adducts and/or phenalkamines.

Most preferably, the curing agent is a polyamine comprising at least two amino groups. To obtain a crosslinked network the curing agent must contain at least three “reactive” hydrogen atoms. “Reactive” hydrogen atom refers to the hydrogen atom that is transferred from the nucleophile to the oxygen atom of the epoxide during the ring opening reaction. Curing active amine groups cannot therefore be tertiary. Tertiary amine containing compounds may however be added to the composition as curing accelerators. The curing agent typically contains at least two curing reactive functional groups.

In one embodiment, the curing agent comprises a benzylamine motif:

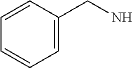

The benzylamine in the curing agent may be optionally substituted either on the ring, the methylene linker, or the N atom although one active hydrogen must remain. Suitable substituents include C1-15 alkyl groups, OH, O—C1-4-alkyl, halogen, cyano, amine and alkyl amine groups (C1-4-N).

In one preferred embodiment, the curing agent is a polyamine curing agent comprising one or more benzylamine structures.

More specifically, the curing agent comprises two or more repeating units, i.e. the curing agent is polymeric or oligomeric. Preferably the curing agent is a polyamine polymer that comprises a benzylamine structure on at least one end of the polyamine polymer chain. The polyamine polymer may comprise benzyl amine structures at both ends of the polymer chain. Each repeating unit may also comprise a benzylamine group. The benzyl amine group may be substituted or unsubstituted.

In one preferred embodiment the curing agent comprises at least two or more benzylamine structures.

In one embodiment the curing agent comprises a benzylated polyalkylene polyamine structure as described in WO2017147138A. The benzylated polyalkylene polyamine structure preferably has a structure as shown below:

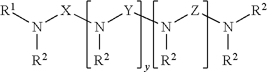

wherein R¹ is substituted or unsubstituted benzyl;
R² is independently selected from R¹ or a hydrogen atom or a group selected from C1-C16 linear, cyclic or branched alkyl, alkenyl and alkylaryl groups;
X, Y and Z are independently selected from C2-C10 alkylene and cycloalkylene groups, preferably ethylene, propylene, butylene, hexylene, cyclohexyldimethylene and cyclohexylene;
y is and integer from 1-7;
z is an integer from 0-4.

Examples of suitable benzylated polyalkylene polyamine structures are benzylated polyethylene polyamines, benzylated polypropylene polyamines, benzylated polyethylene-polypropylene polyamines, and combinations thereof.

Non-limiting examples of polyethylene polyamines include ethylenediamine (EDA), diethylenetriamine (DETA), triethylenetetramine (TETA), tetraethylenepentamine (TEPA), pentaethylenehexamine (PEHA), and other higher polyethylene polyamines. Suitable polypropylene polyamines include, but are not limited to, propylene diamine (PDA), dipropylenetriamine (DPTA), tripropylenetetramine, and other higher polypropylene polyamines. Other polyalkylene polyamines include N-3-aminopropyl ethylenediamine, N,N′-bis(3-aminopropyl)ethylenediamine, and N,N,N′-tris(3-aminopropyl)ethylenediamine, N-3-aminopropyl diethylenetriamine; N-3-aminopropyl-[N′-3-[N-3 aminopropyl]aminopropyl]diethylenetriamine; N,N′-bis(3-aminopropyl) diethylenetriamine; N,N-bis(3-aminopropyl) diethylenetriamine; N,N,N′-tris(3-aminopropyl) diethylenetriamine; N,N′,N″-tris(3-aminopropyl) diethylenetriamine; N,N,N′,N′-tetrakis(3-aminopropyl) diethylenetriamine; N,N-bis(3-aminopropyl)-[N′-3-[N-3-aminopropyl]aminopropyl]-[N′-3-aminopropyl]diethylenetriamine; and N-3-aminopropyl-[N′-3-[N-3-aminopropyl]aminopropyl]-[N′-3-aminopropyl]diethylenetriamine.

The benzylated polyalkylene polyamine structures are typically prepared by a reductive amination of benzaldehyde, including both substituted and unsubstituted benzaldehydes with a polyalkylene polyamine. Examples of substituted benzaldehydes are benzaldehydes where the aromatic ring is substituted with one or more halogen atoms, C1-C4 alkyl, methoxy, ethoxy, amino, hydroxyl or cyano groups. Preferred benzaldehydes are benzaldehyde and vanillin.

In another embodiment, the curing agent is an amine epoxy adduct, such as an adduct made by reacting a bisphenol A epoxy resin with primary diamines. The amine epoxy adduct can be synthesized by reacting the epoxy resin with an excess of the primary diamines, e.g. at 40 to 100° C. The reaction typically takes place in a solvent such as n-butanol or benzyl alcohol.

Preferably the bisphenol A epoxy resin has an EEW of less than 250 g/eq. Suitable primary diamines for the synthesis of the amine epoxy adduct may be ethylenediamine (EDA), diethylenetriamine (DETA), triethylenetetramine (TETA), tetraethylenepentamine (TEPA), pentaethylenehexamine (PEHA), and other higher polyethylene polyamines. Aliphatic primary diamines like 1,3-diaminopropane, 1,4-diaminobutane, 1,5-diaminopentane, 1,5-diamino-2-methylpentane, 1,6-hexanediamine and 2,2,4 (2,4,4)-trimethyl-1,6-hexanediamine may also be used. Primary diamines comprising a cyclic structure, such as, 1,4-diaminocyclohexane, isophorone diamine (IPDA), 1,3-bis(aminomethyl)cyclohexane, 1,4-bis(aminomethyl)cyclohexane, 1,3-bis(aminomethyl)benzene, and 1,4-bis(aminomethyl)benzene may also be used. In a preferred embodiment the primary diamines are a mixture of 1,5-diamino-2-methylpentane and isophorone diamine (IPDA).

The amine epoxy adduct preferably has an average molecular weight of 500 g/mol to 3000 g/mol, more preferably 600 g/mol to 2000 g/mol.

In another embodiment, the curing agent is a reaction product of a phenol, formaldehyde, and a primary diamine e.g. a Mannich base. The phenol may be an unsubstituted or substituted phenol, e.g. alkyl phenol, in one embodiment the phenol is cardanol. When the phenol is cardanol, the curing agent is termed phenalkamine. Mannich bases and phenalkamine curing agents are especially suitable as curing agents in low temperature conditions, such as below 10° C. The use therefore of a phenalkamine curing agent forms a preferred aspect of the invention.

In principle, any primary diamine may be used to synthesize the phenalkamine curing agent. Non-limiting examples of primary diamines include ethylenediamine (EDA), diethylenetriamine (DETA), triethylenetetramine (TETA), tetraethylenepentamine (TEPA), pentaethylenehexamine (PEHA), and other higher polyethylene polyamines. Aliphatic primary diamines like 1,3-diaminopropane, 1,4-diaminobutane, 1,5-diaminopentane, 1,5-diamino-2-methylpentane, 1,6-hexanediamine and 2,2,4 (2,4,4)-trimethyl-1,6-hexanediamine. Primary diamines comprising a cyclic structure, such as, isophorone diamine (IPDA), 1,3-bis(aminomethyl)cyclohexane, 1,4-bis(aminomethylcyclohexane), 1,3-bis(aminomethyl)benzene, and 1,4-bis(aminomethyl)benzene may also be used. Phenalkamines based on 1,3-bis(aminomethyl)benzene and ethylenediamine are preferred.

In another embodiment, the curing agent is not a polyoxyalkylene amine, e.g. a Jeffamine type curing agent.

In another embodiment, the curing agent is not a ketimine or aldimine. The ketimine or aldimine curing agent comprises a reaction product of reactants comprising a polyalkylpolyamine component and a ketone or aldehyde component.

In a preferred embodiment, the curing agent does not comprise a polyoxyalkylene amine or a ketimine or aldimine.

In a preferred embodiment, the curing agent composition is a mixture of N-benzylated alkylene amines and an amine epoxy adduct as described above, e.g. mixed in a weight ratio of 40 to 60 to 60 to 40.

The curing agent composition preferably has an active hydrogen equivalent weight (AHEW) of 50-200 g/eq, more preferred 70-150 g/eq, most preferred 90-110 g/eq.

The number of “active hydrogen equivalents” in relation to the one or more curing agents is the sum of the contribution from each of the one or more curing agents. The contribution from each of the one or more curing agents to the active hydrogen equivalents is defined as grams of the curing agent divided by the active hydrogen equivalent weight of the curing agent, where the active hydrogen equivalent weight of the curing agent is determined as: grams of the curing agent equivalent to 1 mol of active hydrogen.

Preferably the ratio between the hydrogen equivalents of the totality of the curing agents and the totality of epoxy equivalents is in the range of 50:100 to 120:100.

Especially preferred epoxy-based coating compositions have a ratio between the active hydrogen equivalents of the curing agent and the epoxy equivalents of the composition in the range of 60:100 to 110:100 such as 70:100 to 105:100, e.g. 80:100 to 95:100.

The viscosity of the curing agent composition is preferably between 200 and 5000 mPas, more preferred 400-2500 mPas, most preferred 500-1500 mPas.

The curing agent is preferably present in 5.0 to 40 wt % of the primer coating composition, such as 8.0 to 40 wt % of the primer coating composition. More preferably the curing agent is present in an amount of 10 to 30 wt %, especially 10 to 25 wt % of the primer coating composition. If a blend of curing agents is used then these percentages refer to the total curing agent content in the primer layer composition.

Commercial curing agents of use in the invention include Ancamine 1618, Ancamine 2422, Ancamine 2432, Ancamine 2519, Ancamine 2738, Ancamine 2739, Ancamine 2712M all from Evonik, and NX-5594, GX-5135, GX-6027, NX-6654, NC-540, NC-541, NC-541LV, LITE 2001, LITE 2001LV and LITE 2002 all from Cardolite.

### Solvent

The primer coating composition of the invention comprises at least one glycol ether solvent. The use of a glycol ether solvent has been found to enable long pot lives and is also essential to allowing application of the primer layer composition to a wet or rusted substrate. It also acts as a wetting agent for the extenders in the formulation. This solvent ensures therefore that the primer layer composition of the invention adheres to the substrate below even when the substrate is wet or rusted on application of the composition. The glycol ether solvent should be a liquid at room temperature and pressure (1 atm, 23° C.).

The glycol ether solvent can be provided as part of component A and/or as part of component B, preferably component A.

The glycol ether solvent of the invention is preferably a solvent of formula (I):

R—[O—R′]ₓ—OH (I)
wherein x is 1 to 3;
R is a C₁-C₁₆ aliphatic group; and
R′ is a C₁-C₁₆ aliphatic group.

Preferably R and R′ are independently a C₁-C₁₆ linear, cyclic or branched alkyl group, such as C₁-C₁₆ linear or branched alkyl group.

Preferably R and R′ are independently a C₁-C₈ linear, cyclic or branched alkyl group, such as C₁-C₈ linear or branched alkyl group.

Preferably R and R′ are independently a C₁-C₆ linear or branched alkyl group. It is preferred if R′ is an ethylene or propylene repeating unit. It is preferred if x is 1 or 2, especially 1. If x is 2 or 3 then it is preferred if all R′ groups are the same.

Preferably R is a C₂-C₈ linear, cyclic or branched alkyl group, such as C₂-C₈ linear or branched alkyl group. Preferably R is a C₂-C₆ linear, or branched alkyl group.

The glycol ether solvent of the invention is preferably a solvent of formula (II):

R—O—R′—OH (II)
wherein R is a C₁-C₈ linear or branched alkyl group; and
R′ is an ethylene or propylene group.

In a preferred embodiment the solvent is an ethylene glycol ether or a propylene glycol ether such as such as ethylene glycol monomethyl ether, ethylene glycol monoethyl ether, ethylene glycol monobutyl ether, ethylene glycol monophenyl ether, propylene glycol methyl ether, propylene glycol monoethyl ether, propylene glycol n-propyl ether, propylene glycol n-butyl ether, propylene glycol phenyl ether, dipropylene glycol n-propyl ether, dipropylene glycol n-butyl ether or tripropylene glycol n-butyl ether.

In a preferred embodiment the solvent comprises propylene glycol n-butyl ether.

The glycol ether solvent preferably has a boiling point of 250° C. or less, preferably 50 to 200° C., such as 90 to 180° C.

The glycol ether solvent preferably has a Mw of 50 to 400 g/mol, more preferably 80 to 200 g/mol.

Other solvents may also be present. Other suitable solvents include aromatic hydrocarbons, aliphatic hydrocarbons, ketones, esters, alcohols, and ethers. Examples of hydrocarbon solvents include toluene, xylene, light aromatic solvent naphtha [C8-C10] (Solvesso 100) and mineral spirits. Examples of ketones include acetone, methyl ethyl ketone, methyl isobutyl ketone, methyl amyl ketone, methyl isoamyl ketone. Examples of esters include, ethyl acetate, n-butyl acetate, isobutyl acetate, sec-butyl acetate, tert-butyl acetate and propylene glycol methyl ether acetate. Examples of alcohols include, ethanol, propanol, isopropanol, n-butanol, isobutanol, sec-butanol, tert-butanol and benzyl alcohol.

It is preferred to combine xylene or n-butyl acetate or tert-butyl acetate with a glycol ether solvent to achieve the desired surface tolerance and pot life of the coating composition. More preferably, due to health and safety reasons, the glycol ether solvent is a propylene glycol ether. Propylene glycol ethers have good viscosity reducing effect on the composition. Di- and tri-propylene glycol ethers may be used, but due to evaporation rate, the (mono) propylene glycol ethers are preferred. Most preferred is propylene glycol n-butyl ether.

The amount of glycol ether solvent, e.g. a solvent of formula (I), in the primer coating composition is from 1.0 to 15 wt %, preferably 1.0 to 10 wt %, more preferably 2.0 to 8.0 wt % on total weight of the coating composition, ideally 2.0 to 6.0 wt %. If a blend of glycol ether solvents is used then these percentages refer to the total content of any glycol ethers present.

The total amount of solvent in in the primer coating composition is from 2.0 to 15 wt %, preferably 5.0 to 15 wt %, more preferably 5.0 to 12 wt % on total weight of the coating composition, ideally 7.0 to 10.5 wt %.

### Microspheres

The primer coating composition of the invention comprises microspheres such as organic or inorganic microspheres. These microspheres may be coated or uncoated. These microspheres may be hollow or solid. Suitable microspheres are glass beads, uncoated or coated hollow and solid ceramic beads, beads of polymeric materials such as poly(methyl methacrylate), poly(methyl methacrylate-co-ethylene glycol dimethacrylate), poly(styrene-co-ethylene glycol dimethacrylate), poly(styrene-co-divinylbenzene), polystyrene, poly(vinyl chloride), poly(vinylidene fluoride) and poly(vinylidene chloride).

Examples of commercially available hollow organic spherical filler particles are the Dualite® grades E030, E055, E065-135D, E130-055D, E130-095D, E130-105D, E130-040D, E035-FR and E135-025D all from Chase Corporation.

Preferably the primer coating composition comprises solid or hollow, inorganic spherical, microspheres. Suitable solid or hollow, inorganic, spherical, filler particles are commercially available. Examples of commercially available hollow, inorganic, spherical filler particles include Glass Bubbles S28HS, Micro Bubbles H38HS, Fillite Cenosphere, Poraver (expanded glass), Eccospheres, Q-Cel, Sphericel, Thermospheres, Omega spheres (available from e.g. 3M, SMC Minerals, Omya, Poraver, Trelleborg, Potters, Omega) and hollow glass spheres from Hollowlite.

It is preferred if the inorganic, spherical microparticles are hollow. This means the particles have a void or cavity in their centres. This void or empty space is filled with gas, preferably air. Preferred inorganic, spherical, filler particles for use in the present invention are substantially hollow. Thus, preferably the volume of the void or cavity is at least 70 vol % and more preferably at least 80 vol % of the total volume of the particles.

Preferably the microspheres have as low a density as practicable, e.g. the density of the microspheres might be 0.1-1 g/cm³, more preferably 0.2-0.8 g/cm³, and still more preferably 0.3-0.5 g/cm³, e.g. as specified on the technical specification provided by suppliers. This may reflect the fact that the particles are hollow rather than solid.

The microspheres may therefore ensure that the primer layer composition has a low density and high volume solids. The use of microspheres, especially hollow microspheres, makes it possible to keep the binder content low whilst maintaining a high filler content.

Preferably the microspheres present in the coating compositions of the present invention have an isostatic crush strength of at least 5000 psi, e.g. as specified by the supplier in the technical datasheet. This is beneficial as it means that the filler particles are not crushed during processing and thus maintain their ability to provide a low density coating composition. It is also advantageous that the microspheres do not change shape and/or size during processing, so they can pack tightly and achieve a high build in the final coatings formed.

The microspheres present in the coating compositions of the present invention comprise and more preferably consist of glass, ceramic, or plastic. More preferably the microspheres in the coating compositions of the present invention comprise and still more preferably consist of glass. This is because glass particles provide a good balance of crush strength, hardness and conductivity. Optionally the microspheres present in the coating compositions of the present invention may be surface treated. Some examples of surface treatment include treatment to alter the hydrophobicity of the surface, to improve compatibility with the binder and/or to facilitate chemical incorporation into the binder. Preferably the particles are treated with vinyl silane.

In a preferred embodiment therefore the microspheres of the invention are vinyl silane treated microspheres.

The microspheres present in the coating compositions of the invention are substantially spherical and more preferably spherical. This is advantageous as it allows the particles to pack more closely together in the coating compositions of the invention.

Alternatively viewed, the microspheres have a D10 diameter of 1 to 40 μm, more preferably 5 to 35 μm and still more preferably 10 to 30 μm, as determined by ISO 13320:2009 using a Malvern Mastersizer 2000.

Alternatively viewed, the microspheres have a D50 diameter of 10 to 80 μm, more preferably 20 to 70 μm and still more preferably 30 to 55 μm, as determined by ISO 13320:2009 using a Malvern Mastersizer 2000.

Preferably the microspheres have a D90 diameter of 30 to 150 μm, more preferably 50 to 90 μm and still more preferably 50 to 80 μm, as determined by ISO 13320:2009 using a Malvern Mastersizer 2000.

Preferred coating compositions of the present invention comprise 1.0 to 9.0 wt %, more preferably 2.0 to 8.0 wt % and still more preferably 2.0 to 7.0 wt % microspheres, based on the total weight of the composition. If the microspheres content exceeds the range in claim 1 the composition may fail the cathodic disbondment test.

This amount of microspheres ensures therefore that the primer layer composition of the invention provides corrosion protection to the substrate below even when the substrate is wet or rusted on application of the composition . . .

The microspheres can be provided as part of component A and/or as part of component B, preferably component A.

### Hydrocarbon Resin

The primer coating composition of the invention may also comprise a hydrocarbon resin. A wide range of hydrocarbon resins are suitable for including in the coating composition. The hydrocarbon resin may be a petroleum resin or a xylene formaldehyde resin.

Examples of petroleum resins suitable in the present invention include an aromatic petroleum resin obtained by polymerizing a C9 fraction (e.g. styrene derivatives such as alpha methylstyrene, o, m, p-cresol, indene, methyl indene, cumene, napthalene or vinyltoluene) obtained from a heavy oil that is produced as a by-product by naphtha cracking, an aliphatic petroleum resin obtained by polymerizing a C5 fraction such as 1,3-pentadiene or isoprene, 2-methyl-2-butene, cyclopentadiene, dicyclopentadiene or cyclopentene.

Also employable in the invention are a copolymer-based petroleum resin obtained by copolymerizing the C9 fraction and the C5 fraction, an aliphatic petroleum resin wherein a part of a conjugated diene of the C5 fraction such as cyclopentadiene or 1,3-pentadiene is cyclic-polymerized, a resin obtained by hydrogenating the aromatic petroleum resin, and an alicyclic petroleum resin obtained by polymerizing dicyclopentadiene. Mixtures of diaryl and triaryl compounds obtained from reaction of C9 blends under catalytic conditions are also possible to utilize.

Preferably the hydrocarbon resin is a resin obtained by polymerizing a C9 fraction. The hydrocarbon resin may contain an OH-functionality or may be free of OH-functionalities.

The hydrocarbon resin may have a viscosity of 10 to 10000 mPas. More preferably the viscosity is 20 to 5000 mPas, most preferred 40 to 200 mPas.

The primer coating composition of the present invention preferably comprises 0 to 10 wt % hydrocarbon resin, based on the total weight of the composition, preferably 2.0 to 7.0 wt % based on the total weight of the composition. If a blend of hydrocarbon resins is used then these weight percentages refer to the total content of hydrocarbon resin.

The hydrocarbon resin can be provided as part of component A and/or as part of component B, preferably component A.

Examples of suitable commercially available hydrocarbon resins are Novares TL 10, Novares LC 15, Novares L 100, and Novares LA 300 from Rain Carbon Inc., Hirenol PL-150 and Hikotack LP-9800S from Kolon Industries, and Epodil LV5 from Evonik.

### Reactive Diluent

The primer layer coating composition may further comprise a reactive diluent, preferably formed from a modified epoxy compound.

Examples of such reactive diluents include phenyl glycidyl ether, alkyl glycidyl ether (number of carbon atoms in alkyl group: 1 to 16), glycidyl ester of versatic acid (R⁴R⁵R⁶C—COO-Gly, where R⁴R⁵R⁶ are alkyl groups such as C8 to C10 alkyl and Gly is a glycidyl group), olefin epoxide (CH₃—(CH₂) n-Gly, wherein n=11 to 13, Gly: glycidyl group), 1,6-hexanediol diglycidyl ether (Gly-O—(CH₂)₆—O-Gly), neopentyl glycol diglycidyl ether (Gly-O—CH₂—C(CH₃)₂—CH₂—O-Gly), trimethylolpropane triglycidyl ether (CH₃—CH₂—C(CH₂—O-Gly) 3), and C1-20-alkylphenyl glycidyl ether (preferably C1-5 alkylphenylglycidyl ether), e.g., methylphenyl glycidyl ether, ethylphenyl glycidyl ether, propylphenyl glycidyl ether and glycidyl neodecanoate. Another preferred option is Cardolite NC-513 derived from the reaction of epichlorohydrin and an oil obtained from the shells of cashew nuts.

Of the above reactive diluents, preferable are aliphatic reactive diluents. The aliphatic reactive diluents are preferably formed from the reaction of a compound comprising at least one aliphatic epoxide functionality with an aliphatic alcohol or polyol such as 1,6-hexanediol diglycidyl ether or 1,4-butanediol diglycidyl ether. Aliphatic glycidyl ethers of chain length 8 to 14 are also preferred. The preferred reactive diluent will be aliphatic as it contributes to the flexibility of the coating. The use of p-TBPGE is also possible (para tertiary butyl phenyl glycidyl ether).

It is preferred if the reactive diluent is polyfunctional as opposed to monofunctional as this speeds up the drying process and the increased crosslinking density. This also contributes to better anticorrosive properties.

The above reactive diluents can be used singly or in combination of two or more diluents.

In the primer layer composition as a whole, the reactive diluent is desirably contained in an amount of 0 to 20% by weight, preferably 1.0 to 15% by weight, e.g. 2.0 to 10 wt %, especially 2.0 to 7.0 wt %. If a blend of reactive diluents is used then these percentages refer to the total content of reactive diluent.

By adding the reactive diluent in the above amount, viscosity of the main primer layer composition is lowered to allow preparation of a high-solids composition.

Preferably the viscosity of the reactive diluent is <100 cP, preferably <50 cP, most preferably viscosity<30 cP at 23° C. and 50% RH, determined by the cone and plate method according to ISO 2884-1:2006.

The epoxy equivalent weight (EEW) of the reactive diluents is preferably 100 to 500 g/eq, preferably 100 to 300 g/eq, most preferably 120 to 170 g/eq.

The reactive diluent can be provided as part of component A and/or as part of component B, preferably component A.

### Fillers and Pigments

The coating composition optionally comprises fillers, colour pigments and anticorrosive pigments.

The fillers comprise organic and inorganic fillers, the inorganic fillers may be naturally occurring, i.e. mined or of synthetic origin, and may or may not be surface treated.

Suitable types of inorganic fillers may be selected from the following groups of minerals; silicates, phyllosilicates, silicas, carbonates, barytes, metal oxides, metals, phosphates, halides, sulfides and sulfates. Organic fillers may comprise organic polymers or polymer blends, graphite, graphene, graphene oxide, fullerenes, carbon nanotubes, carbon fibers as well as organic polymer particles, e.g. core-shell particles containing an organic compound(s) such as a dye, resin and/or an organic liquid.

Non-limiting examples of fillers that can be used in the coating composition according to the present invention are nepheline syenite, talcum, plastorite, chlorites, chrysolite, mica, pyrophyllite, feldspars, bentones, kaolins, mica/muscovite, clays, wollastonite, quartz, christobalite, glass flakes, glass fibers, fumed silica, calcium silicate, pumice, diatomaceous earth, calcium carbonate, magnesium carbonate, calcium sulfate, dolomite, barium sulfate, iron oxide, micaceous iron oxide, zinc oxide, aluminium oxide, aluminium hydroxide, aluminium flakes, zinc flakes, and solid silicone resins, which are generally condensed branched polysiloxanes. Some fillers such as fumed silica and clays may have a thickening effect on the coating composition. Inorganic core-shell particles containing an organic compound(s) such as a dye, resin and/or an organic liquid may also be used.

Examples of preferred fillers are talc, feldspar, barium sulphate, wollastonite, mica, dolomite, and calcite. Especially preferred are combinations of talc and dolomite (or calcite), e.g. talc with dolomite or talc with calcite, or a mixture of dolomite, calcite and talc

The colour pigment(s) may be inorganic pigments, organic pigments or a mixture thereof. The pigments may be surface treated.

Representative examples of pigments include black iron oxide, red iron oxide, yellow iron oxide, titanium dioxide, zinc oxide, carbon black, graphite, red molybdate, yellow molybdate, zinc sulfide, antimony oxide, sodium aluminium sulfosilicates, quinacridones, phthalocyanine blue, phthalocyanine green, indanthrone blue, cobalt aluminium oxide, carbazoledioxazine, isoindoline orange, bis-acetoaceto-tolidiole, benzimidazolone, quinaphthalone yellow, isoindoline yellow, tetrachloroisoindolinone, and quinophthalone yellow, metallic flake materials (e.g. aluminium flakes). In one preferred embodiment the titanium dioxide is surface treaded with a silicone compound, a zirconium compound, an aluminium compound or a zinc compound.

Anticorrosive pigments and/or additives may be included in the coating composition to improve its anticorrosive performance. The types of anticorrosive pigments and additives are not specifically limited and any suitable anticorrosive pigments and additives may be used. The anti-corrosive pigments may be based on borates, borosilicates, phosphates, orthophosphates, polyphosphates, phosphosilicates, silicates combined with a metal or metal cation such as zinc, aluminium, molybdenium, calcium, strontium, aluminium magnesium, and barium. The anti-corrosive pigments may be modified, e.g. surface modified, and/or contain complex ions and chelates.

Non-limiting examples of suitable anti-corrosive additives may be imidazoles (in pure form or contained in a polymer or resin matrix) polymers and other organic substances such as C12-14-(tert)-alkylamines, (2-benzothiazolylthio)-butanedioic acid, 4-oxo-4-p-tolylbutyric acid, adduct with 4-ethylmorpholine, (2-benzothiazolylthio) butanedioic acid, poly(3-ammoniumpropylethoxysiloxane) dodecanoate, ammonium benzoate, and morpholine.

Examples of suitable commercially available anticorrosive pigments and additives may be: Halox 520, Halox 570, Halox 630, Halox 350, Halox 430, Halox 700, Halox BW-11. Halox BW-191, Halox CW-314, Halox CW-491, Halox CZ-170, Halox SW-111, Halox SZP-391, Halox SZP-395, Halox Z-Plex 111, Haloz Z-Plex 250 and Halox Z-Plex 750 from Halox, Habicor CS, Habicor Si, Habicor ZS, Habicor ZA, Habicor ZN, Habicor ZO, Habicor ZM, Habicor AZ, Habicor SP, Habicor CP4295, Habicor Habicor ZP3850, Habicor ZP3860, Habicor 1000 and Habicor 1001 from Habicor and AX1 from Hexigone.

The coating composition may comprise of 0 to 15 wt %, e.g. 0.1-10 wt % of anticorrosive pigments/additives. The coating composition may comprise zinc phosphate and/or calcium phosphate at a loading of between 0 and 10 wt %.

Pigments and fillers may be added to the paint composition in the form of a powder or as a slurry or concentrate.

The amount of the at least one filler or pigment, is preferably in the range 0.05 to 50 wt %, preferably in the range 1 to 45 wt % more preferably 5 to 40 wt % and still more preferably 10 to 40 wt %, based on the total weight of the coating composition.

### Additives

The coating composition of the present invention optionally comprises one or more additives. Examples of additives that may be present in the coating composition of the invention include, rheology modifiers such as thixotropic agents, thickening agents and anti-settling agents, dispersing agents, wetting agents, defoamers, and plasticizers. Suitable additives are not necessarily limited to additives developed and sold for use in paint. Additives developed and sold for use in for instance adhesives, building materials, plastics/resins, drilling fluids, paper coatings and pigment concentrates may be used if compatible with the coating composition. As the efficiency of any additive used in coating compositions may, to a great extent, be influenced by the other raw materials and additives contained therein, it is important that suitable types and concentrations of additives are determined by testing. In many cases it may be necessary and/or useful to add several different additives of any given type, i.e. two or more defoamers or two or more rheology modifiers, to achieve the desired properties/efficiency.

Defoamers and air release additives, hereby just referred to as defoamers, are commonly used in epoxy coatings to aid release of air incorporated during manufacture and application of the coating composition. The type of defoamer is not specifically limited and any suitable type can be used. Common defoamers can be divided into mineral oil defoamers, silicon defoamers and polymer defoamers. Commercially available defoamers often contain a mixture of these types, often in combination with solvents and solid particles. Non-limiting examples of defoamers that can be used are Byk-011, Byk-012, Byk-014, Byk-015, Byk-016, byk-017, Byk-018, Byk-019, Byk-021, Byk-022, Byk-023, Byk-024, Byk-025, Byk-028, Byk-035, Byk-037, Byk-038, Byk-039, Byk-044, Byk-051N, Byk-052N, Byk-053N, Byk-054, Byk-055, Byk-057, Byk-070, Byk-072, Byk-077, Byk-081, Byk-085, Byk-088, Byk-092, Byk-093, Byk-094, Byk-141, Byk-1610, Byk-1611, Byk-1615, Byk-1616, Byk-1617, Byk-1630, Byk-1640, Byk-1650, Byk-1707, Byk-1709, Byk-1710, Byk-1711, Byk-1719, Byk-1723, Byk-1724, Byk-1730, Byk-1740, Byk-1751, Byk-1752, Byk-1758, Byk-1759, Byk-1760, Byk-1770, Byk-1780, Byk-1781, Byk-1785, Byk-1786, Byk-1788, Byk-1789, Byk-1790, Byk-1791, Byk-1794, Byk-1795, Byk-1796, Byk-1797, Byk-1799, Byk-A 515, Byk-A 525, Byk-A 530, Byk-A 535, Byk-A 550, Byk-A 555 and Byk-A 560 from BYK, Tego Airex 901 W, Tego Airex 901 W N, Tego Airex 902 W, Tego Airex 902 W N, Tego Airex 904 W, Tego Airex 904 W N, Airase 4500, Airase 4655, Airase 5355, Airase 5655, Airase 8070, Surfonyl 104, Surfonyl 107L, Surfonyl 420, Tego Foamex 3062, Tego Foamex 8050, Tego Foamex 843, Tego Foamex 844, Tego Foamex 845 Tego Foamex 883, Tego Foamex 1488, Tego Foamex 810, Tego Foamex 811, Tego Foamex 812, Tego Foamex815, Tego Foamex822, Tego Foamex 823 and Tego Foamex 825 from Evonik.

A rheology modifier may be employed to adjust the rheological profile of the coating composition to prevent settling and floating issues, as well as to adjust flow and to improve sag resistance, workability, application properties and the stabilization of pigment and extender particles. The type of rheological modifier is not specifically limited and any suitable rheological modifier can be used but should be chosen based on which properties need to be improved and based on compatibility with the rest of the formulation. Non-limiting examples of suitable rheological modifiers may be organically modified clays such as bentonite, hectorite and attapulgite clays, unmodified clays, organic wax thixotropes based on castor oil and castor oil derivatives, amide waxes, rheology modifiers based on an acrylic, urea, modified urea, polyurethane, amide or polyamide backbone, and fumed silica. The active constituents of the rheological modifier may be modified with functional groups such as for instance polyether and alcohol groups, or surface treated with for instance silanes which is common with fumed silica. Non-limiting examples of commercially available rheology modifiers may be TS-610, TS-530, EH-5, H-5, and M-5 from Cabot and Aerosil® R972, Aerosil® R974, Aerosil® R976, Aerosil® R104, Aerosil® 200, Aerosil® 300, Aerosil® R202, Aerosil® R208, Aerosil® R805, Aerosil® R812, Aerosil® 816, Aerosil® R7200, Aerosil® R8200, Aerosil® R9200, Aerosil® R711 from Evonik, Bentone SD2 from Elementis, Exilva from Borregård, Crayvallac ultra and Crayvallac LV from Arkema. Preferably the rheology modifier comprises a micronized amide wax and/or a fumed silica and/or a clay. Preferably the rheology modifier is present in the composition of the invention in an amount of 0 to 10 wt %, more preferably 0.1 to 6 wt % and still more preferably 0.1 to 3.0 wt %, based on the total weight of the composition.

Wetting and dispersing agents may be added to the coating composition to facilitate dispersion and wetting of the pigment and filler particles, thus making it easier to break up agglomerates during production, preventing re-flocculation and settling in wet paint as well as formation of Bénard cells in curing paint, reducing the paints viscosity, and increasing its colour strength and colour stability. The wetting and dispersing agents may be non-ionic, cationic, anionic or comprise a mixture of the beforementioned. Furthermore, the wetting and dispersing agent may consist of polymers, or non-polymeric organic molecules or a mixture thereof. Non-limiting examples of suitable types of wetting and dispersing agents may be fatty acids, lecithins, polysorbates, polyacrylamides, polyethercarboxylates, polycarboxylates, polyalkylene glycols, polyethers and polyacrylates. Non-limiting examples of commercially available wetting and dispersing agent may be, Disperbyk-102, Disperbyk-106, Disperbyk-109, Disperbyk-142, Disperbyk-161, Disperbyk-180, Disperbyk-182, Disperbyk-2000, Disperbyk-2014, Disperbyk 2055, Disperbyk-2059, Disperbyk-2070, Disperbyk-2152 from BYK, Colorol F from Evonik, Adlec soy lecithin and Yelkin soy lecithin from ADM. Preferably the wetting and dispersing agent comprises soy lecithin. Preferably the wetting and dispersing agent is present in an amount of 0 to 1.5 wt %, more preferably 0.1 to 1 wt %.

Viewed from another aspect the invention provides a primer coating composition comprising:
(i) 5.0 to 40 wt % epoxy resin;
(ii) 2.0 to 15 wt % silane;
(iii) a curing agent;
(iv) 1.0 to 15 wt % of glycol ether solvent;
(v) 1.0 to 9.0 wt % microspheres;
(vi) 0 to 10 wt % hydrocarbon resin; and
(vii) 0 to 20 wt % reactive diluent.

Viewed from another aspect the invention provides a primer coating composition comprising:
(i) 10 to 40 wt % epoxy resin;
(ii) 2.5 to 10 wt % silane;
(iii) a curing agent;
(iv) 1.0 to 10 wt % of glycol ether solvent;
(v) 1.0 to 9.0 wt % microspheres;
(vi) 0 to 10 wt % hydrocarbon resin; and
(vii) 0 to 15 wt % reactive diluent.

Viewed from another aspect the invention provides a primer coating composition comprising:
(i) 10 to 40 wt % epoxy resin;
(ii) 2.5 to 8.0 wt % silane;
(iii) a curing agent;
(iv) 2.0 to 8.0 wt % of glycol ether solvent;
(v) 2.0 to 8.0 wt % microspheres;
(vi) 0 to 10 wt % hydrocarbon resin; and
(vii) 0 to 15 wt % reactive diluent.

Viewed from another aspect the invention provides a primer coating composition comprising:
(i) 10 to 40 wt % epoxy resin;
(ii) 2.5 to 8.0 wt % silane;
(iii) a curing agent;
(iv) 2.0 to 6.0 wt % of glycol ether solvent;
(v) 2.0 to 7.0 wt % microspheres;
(vi) 0 to 10 wt % hydrocarbon resin; and
(vii) 2.0 to 10 wt % reactive diluent.

### Preparation of the Primer Composition

The primer composition may be prepared by any suitable technique that is commonly used within the field of paint production. Thus, the various constituents may be mixed together using a high speed disperser, a ball mill, a pearl mill, a three-roll mill, an inline mixer etc. Microspheres are preferably added in the letdown phase of the preparation of the coating composition. The paints according to the invention may be filtered using bag filters, patron filters, wire gap filters, wedge wire filters, metal edge filters, EGLM turnoclean filters (ex Cuno), DELTA strain filters (ex Cuno), and Jenag Strainer filters (ex Jenag), or by vibration filtration.

The primer composition to be used herein are conveniently prepared by mixing the components. As an example, the first composition (Component A) and the curing agent composition (Component B) can be mixed by adding the curing agent Component B to the epoxy Component A and stirring well until the mixture is homogeneous. The mixture is immediately ready for application, e.g. by spray application, but may also be given an induction time prior to application. The mixing ratio is determined readily by the skilled person based on the target percentages in the final primer layer composition and the amounts and equivalent weights of epoxy functional compounds in Component A and the amounts and equivalent weights of active H containing compounds (primary and secondary amine containing compounds) in Component B before mixing of the components.

### Application of the Primer Composition

The primer composition can be applied to a substrate (in particular a steel structure) by well-known standard application methods like conventional air-spraying or by airless- or airmix-spraying equipment or 2K airless spray pumps (or alternatively by means of a brush or a roller, in particular when used as a stripe coat). Preferably the composition is applied at ambient conditions without pre-heating the coating composition.

The substrate is one that can be wet or moist or one that is rusted or both, such as flash rusted.

### Film Thickness

The coating is typically applied in a total dry film thickness of 75 to 800 μm, preferably 100 to 500 μm, such as 150 to 350 μm. It is preferred that the dry film thickness of the primer layer is at least 100 μm. The applied film thickness might vary depending on the nature of substrate being coated and its predicted exposure scenario. The desired film thickness might require the application of multiple coats of the composition, e.g. two coats.

### Curing

Once a substrate is coated with the coating, the coating must be cured. The primer layer may cure spontaneously. Whilst irradiation and heat may be used to encourage curing, the compositions of the invention cure at ambient temperature without further intervention.

Whilst it is preferred to apply a single coating, as the volatile content of the coating of the invention is so low, it is possible to apply a further coating whilst the primer layer is “wet”. There is no requirement therefore to wait for the first coating to cure before applying a further coating. In order to build-up layer thickness, it is known to apply multiple layers of the primer coating but conventionally, each layer is cured (dried) before a further layer is applied. In the present invention, application of further layers can be carried out on a wet (or uncured) primer layer. This speeds up the application process.

In a further aspect therefore the invention includes a process in which further coats of the primer layer coating composition are applied to an undercoat of the primer layer composition without an intermediate curing step. Alternatively viewed, the invention includes a process in which further coats of the primer layer coating composition are applied to an undercoat of the primer layer composition before the undercoat has cured.

The invention will now be described with reference to the following non limiting examples.

### Analytical Methods

### General Procedure for Preparation of the Compositions

Component A of the primer layer was made by mixing all the indicated ingredients (in parts by weight) in a conventional manner known to the person skilled in the art. Component A was then subsequently mixed with component B prior to application. The primer layer is typically applied by airless spraying to a steel substrate.

### Calculation of Densities, Volume Percent Solids, Volatile Organic Compounds and Pigment Volume Concentration

The densities, volume percent solids (volume solids %), and the theoretical volatile organic compounds (VOC) content of the compositions were calculated according to ASTM D5201-05a (2020).

Pigment volume concentration (PVC) for the compositions were determined by calculation according to the formula PVC=((Vp+Vf)/(Vp+Vf+Vb))*100. Where Vp is the volume of pigments, Vf is the volume of fillers, including glass spheres, and Vb is the volume of binders.

### Determination of Viscosity

The viscosity of the binders and paint compositions are determined according to ISO 2884-1:2006 (ASTM D4287) using a cone and plate viscometer set at a temperature of 23° C. at 50% RH and providing viscosity measurement range of 0-10 P at 10000 s⁻¹.

The Stormer viscosity (KU) was carried out according to ASTM D 562 with a stormer viscometer at 23° C.

### Cathodic Disbondment Testing

The cathodic disbondment testing was carried out according to ASTM G8. The test duration was 30 days. The compositions were applied in at wet film thickness corresponding to 2×150 μm dry film thickness (DFT) to sand blasted carbon steel panels of dimension 150×75×3 mm with a cleanliness of Sa 2½. The coatings were cured for 7 days at ambient conditions prior to the cathodic disbondment testing.

### Adhesion Testing of Coating Applied to Wet Substrates

The pull-off adhesion testing was conducted according to ISO 4624:2016. The compositions were applied in at wet film thickness corresponding to 2×150 μm dry film thickness (DFT) to wet sand blasted carbon steel panels of dimension 150×75×3 mm. The wet panels were prepared by soaking the sand blasted carbon steel panels in water, letting the water drip off and apply coating immediately thereafter. Based on the difference in mass between dry and wet panels and the surface are of the panel, the amount of residual water on the wet panels was 40 to 45 g/m². Before soaking in water, the steel panels had a cleanliness of Sa 2½. The coatings were cured for 7 days at ambient conditions prior to pull-off adhesion testing.

### Examples

The following materials are used:

TABLE 1

| Materials | Properties of the materials |
|---|---|
| Bisphenol A based epoxy | Diglycidyl ether of bisphenol A, EEW |
| binder | 182-192 g/eq |
| Di-functional reactive | 1,6-hexanediol diglycidyl ether, EEW |
| diluent | 145-160 g/eq |
| Hydrocarbon resin | OH-functionality 0, viscosity 50-150 |
| | mPas |
| Filler 1 | Talc |
| Filler 2 | Microdol, dolomite, CaMg(CO₃)₂ |
| Filler 3 | Calcite, CaCO₃ |
| Microspheres | Hollow glass spheres, surface treated with |
| | vinyl silane |
| | D90 70 μm |
| | D50 40 μm |
| | D10 22 μm |
| | Density: 0.36-0.40 g/cm³ |
| | Crush strength 5500 psi |
| Pigment 1 | TiO₂ |
| n-butanol | |
| Propylene glycol n-butyl ether | |
| n-butyl acetate (nBuOAc) | |
| Xylene | |
| Benzyl alcohol (BnOH) | |
| Wetting and dispersing agent | Soya lecithin |
| Rheology modifier | Micronized amide wax |
| Defoamer | Polysiloxane based defoamer |
| Epoxysilane | (3-glycidoxypropyl)trimethoxysilane |
| Curing agent 1 | Curing agent comprising a cycloaliphatic |
| | amine. The curing agent comprise an |
| | amine-epoxy adduct of IPDA and 1,5- |
| | diamino-2-methylpentane, 74% solids in |
| | BnOH, AHEW 100 g/eq as supplied. |
| Curing agent 2 | Curing agent comprising a benzylamine |
| | structural motif. The curing agent |
| | comprise a benzylated polyalkylene |
| | polyamine, 100% solids, AHEW 95 g/eq. |
| Curing agent 3 | Curing agent comprising a benzylamine |
| | structural motif. The curing agent is a |
| | phenalkamine based on 1,3- |
| | bis(aminomethyl)benzene and 1,5- |
| | diamino-2-methylpentane. 100% solids, |
| | AHEW 110 g/eq. |
| Curing agent 4 | Curing agent comprising a benzylamine |
| | structural motif. The curing agent is a |
| | phenalkamine based on ethylenediamine, |
| | 70% solids in a mixture of xylene and n- |
| | BuOH, AHEW 162 g/eq. |
| Colorants | Colorants comprising black and yellow |
| | pigments |

TABLE 2
Inventive examples (wt %)

| | E1 | E2 | E3 | E4 |
|---|---|---|---|---|
| Component A | | | | |
| Bisphenol A based | 26 | 27 | 26 | 26 |
| epoxy binder | | | | |
| Propylene glycol n- | 3.5 | 3.8 | 3.5 | 3.5 |
| butyl ether | | | | |
| nBuOAc | | | 4 | |
| xylene | 4 | 4 | | 4 |
| n-butanol | | | | |
| BnOH | 2 | 2 | 2 | 2 |
| Hydrocarbon resin | 5 | 5.2 | 5 | 5 |
| Wetting and | 0.4 | 0.4 | 0.4 | 0.4 |
| dispersing agent | | | | |
| Pigment 1 | 4 | 4 | 4 | 4 |
| Filler 1 | 20 | 20 | 20 | 20 |
| Filler 2 | 19.3 | 19.2 | 19.3 | 19.3 |
| Filler 3 | | | | |
| Microspheres | 6 | 4.2 | 6 | 6 |
| Di-functional reactive | 3 | 3.2 | 3 | 3 |
| diluent | | | | |
| Epoxysilane | 5 | 5.2 | 5 | 5 |
| Rheology modifier | 1 | 1 | 1 | 1 |
| Defoamer | 0.3 | 0.3 | 0.3 | 0.3 |
| Colorants | 0.5 | 0.5 | 0.5 | 0.5 |
| Total A | 100 | 100 | 100 | 100 |
| Component B | | | | |
| Curing agent 1 | 50 | 50 | 50 | 0 |
| Curing agent 2 | 50 | 50 | 50 | 0 |
| Curing agent 3 | 0 | 0 | 0 | 60 |
| Curing agent 4 | 0 | 0 | 0 | 40 |
| Total B | 100 | 100 | 100 | 100 |
| Mixing ratio by | 100:16 | 100:17 | 100:16 | 100:20 |
| weight (A:B) | | | | |

TABLE 3
Comparative examples

| | CE1 | CE2 | CE3 | CE4 | CE5 |
|---|---|---|---|---|---|
| Component A | | | | | |
| Bisphenol A based | 22.4 | 24 | 26 | 26 | 26 |
| epoxy binder | | | | | |
| Propylene glycol | 4.1 | 4 | | 3.5 | 3.5 |
| n-butyl ether | | | | | |
| nBuOAc | | | | | |
| xylene | 3.6 | 4.5 | 4 | 4 | 4 |
| n-butanol | | | 3.5 | | |
| BnOH | 2 | 2 | 2 | 2 | 2 |
| Hydrocarbon resin | 7.1 | 7 | 5 | 5 | 5 |
| Wetting and | 0.4 | 0.4 | 0.4 | 0.4 | 0.4 |
| dispersing agent | | | | | |
| Pigment 1 | 4.1 | 4 | 4 | 4 | 4 |
| Filler 1 | 20.4 | 20 | 20 | 20 | 20 |
| Filler 2 | | | 19.3 | 19.3 | 19.3 |
| Filler 3 | 26.4 | 13.9 | | | |
| Microspheres | | 11 | 6 | 6 | 6 |
| Di-functional | 3.1 | 3 | 3 | 8 | 6 |
| reactive diluent | | | | | |
| Epoxysilane | 5.1 | 5 | 5 | | 2 |
| Rheology modifier | 0.5 | 0.5 | 1 | 1 | 1 |
| Defoamer | 0.3 | 0.2 | 0.3 | 0.3 | 0.3 |
| Colorants | 0.5 | 0.5 | 0.5 | 0.5 | 0.5 |
| Total A | 100 | 100 | 100 | 100 | 100 |
| Component B | | | | | |
| Curing agent 1 | 50 | 50 | 50 | 50 | 50 |
| Curing agent 2 | 50 | 50 | 50 | 50 | 50 |
| Total B | 100 | 100 | 100 | 100 | 100 |
| Mixing ratio by | 100:15 | 100:15.7 | 100:16 | 100:17.8 | 100:17.3 |
| weight (A:B) | | | | | |

TABLE 4
Primer composition properties

| | E1 | E2 | E3 | E4 | CE1 | CE2 | CE3 | CE4 | CE5 |
|---|---|---|---|---|---|---|---|---|---|
| VOC [g/L] | 141 | 150 | 141 | 126 | 174 | 139 | 141 | 142 | 142 |
| theoretical | | | | | | | | | |
| % Volume | 85 | 84 | 85 | 86 | 81 | 85 | 84 | 85 | 85 |
| solids | | | | | | | | | |
| PVC | 40 | 35 | 40 | 37 | 29 | 48 | 40 | 39 | 39 |
| Initial viscosity | 624 | 491 | 525 | 544 | 460 | 900 | 548 | 721 | 692 |
| [mPas] | | | | | | | | | |
| Viscosity 1 h | 1960 | 1964 | 1950 | 1754 | 1024 | 1650 | 2240 | 2640 | 2700 |
| after mixing of | | | | | | | | | |
| Component A | | | | | | | | | |
| and Component | | | | | | | | | |
| B [mPas] | | | | | | | | | |
| Density | 1.235 | 1.279 | 1.236 | 1.223 | 1.475 | 1.096 | 1.231 | 1.236 | 1.237 |

In Table 4, above, the theoretical physical parameters of the coating compositions as well as the measured viscosities can be compared. The results show that CE1 with no glass spheres has a higher VOC and density than E1-E4. CE3-CE5 have a viscosity of more than 2000 mPas 1 h after mixture of component A and B, meaning that these compositions have a shorter pot life than the other compositions. These compositions lack the glycol ether (CE3), silane (CE4) or contain low levels of silane (CE5). The pot life of CE3-CE5 demonstrates therefore that low levels of silane, or the use of n-butanol instead of glycol ether gives a higher viscosity more rapidly.

Test results from cathodic disbondment testing and adhesion testing is shown in Table 5. The results from the Cathodic disbondment testing were graded on a scale from 1-3 based on the following criteria:
1: No blisters, disbondment up to 3 mm—good
2: No blisters, disbondment 3 to 8 mm—acceptable
3: Blisters, and/or disbondment above 8 mm—failure

The results from the pull-off adhesion tests on moist and wet substrates were graded on a scale from 1-3 based on the following criteria:
1: Cohesive failure in first or second coat
2: Partly (0-50%) adhesive failure between substrate and first coat, rest is cohesive failure
3: More than 50% adhesive failure between substrate and first coat
Options 2 and 3 are deemed “fail” in the adhesion test.

TABLE 5
Cathodic disbondment testing and adhesion
testing on wet substrates

| | E1 | E2 | E3 | E4 | CE1 | CE2 | CE3 | CE4 | CE5 |
|---|---|---|---|---|---|---|---|---|---|
| ASTM G8 | 1 | 1 | 1 | 1 | 1 | 3 | | 2 | 1 |
| Cathodic | | | | | | | | | |
| disbondment | | | | | | | | | |
| Adhesion | 1 | 1 | 1 | 1 | | | 3 | 3 | 3 |
| testing on wet | | | | | | | (fail) | (fail) | (fail) |
| surface | | | | | | | | | |

Good adhesion between the substrate and the primer coat is important for the performance of an anticorrosive primer. Hence, if a composition fails the adhesion test it is deemed unsuitable for use as a high performing anticorrosive primer.

The adhesion test results demonstrate that the silane as well as the glycol ether solvent are essential for the adhesion to a wet substrate. Example 3 demonstrates that a xylene free formulation may be used.

When the amount of glass spheres is too high (CE2), the formulation fails in the cathodic disbondment test. As CE2 failed the G8 testing, it was not tested further on wet substrate. Similarly, as CE3 fails on the wet substrate test it is not an interesting composition for this type of primer coating and was not subjected to cathodic disbondment.

The primer composition of the present invention (Examples 1-4) can be applied on moist or wet surfaces. The composition can also be applied on rusted and flash rusted substrates.

1. A primer coating composition comprising:
(i) an epoxy resin;
(ii) 2.0 to 15 wt % of silane;
(iii) a curing agent, such as an amine based curing agent;
(iv) a glycol ether solvent; and
(v) 1.0 to 9.0 wt % microspheres.

2. A primer coating composition as claimed in claim 1 wherein the microspheres have a D90 diameter of 30 to 150 μm, more preferably 50 to 90 μm and still more preferably 50 to 80 μm, as determined by ISO 13320:2009 using a Malvern Mastersizer 2000.

3. A primer coating composition as claimed in any preceding claim further comprising reactive diluent.

4. A primer coating composition as claimed in any preceding claim wherein the epoxy resin is a liquid.

5. A primer coating composition as claimed in any preceding claim wherein the epoxy resin is bisphenol based, preferably bisphenol A based.

6. A primer coating composition as claimed in any preceding claim wherein the glycol ether solvent is of formula (I):
R—[O—R′]ₓ—OH (I)
wherein x is 1 to 3;
R is a C₁-C₁₆ aliphatic group; and
R′ is a C₁-C₁₆ aliphatic group.

7. A primer coating composition as claimed in any preceding claim wherein the glycol ether solvent is of formula (II):
R—O—R′—OH (II)
wherein R is a C₁-C₈ linear or branched alkyl group; and
R′ is an ethylene or propylene group, preferably propylene glycol n-butyl ether.

8. A primer coating composition as claimed in any preceding claim wherein the microspheres comprise glass spheres.

9. A primer coating composition as claimed in any preceding claim wherein the silane is an epoxy silane.

10. A primer coating composition as claimed in any preceding claim wherein the curing agent comprises a N-benzylated polyalkylene amine or phenalkamine, especially phenalkamine based on 1,3-bis(aminomethyl)benzene and ethylenediamine.

11. A primer coating composition as claimed in any preceding claim wherein the viscosity of the composition immediately on formation is 200-1000 mPas at 23° C.

12. A primer coating composition as claimed in any preceding claim wherein glycol ether solvent is present in an amount from 1.0 to 10 wt % of the composition.

13. A primer coating composition as claimed in any preceding claim wherein the pot life at 23° C. is at least 30 minutes.

14. A primer coating composition as claimed in any preceding claim having a VOC of 220 g/L or less.

15. A primer coating composition as claimed in any preceding claim comprising:
(i) 10 to 40 wt % epoxy resin;
(ii) 2.5 to 10 wt % silane;
(iii) a curing agent;
(iv) 2.0 to 10 wt % of glycol ether solvent;
(v) 2.0 to 9.0 wt % microspheres;
(vi) 0 to 10 wt % (e.g. 2.0 to 10 wt %) hydrocarbon resin; and
(vii) 0 to 15 wt % (e.g. 2.0 to 15 wt %) reactive diluent.

16. A kit suitable for the preparation of a primer coating composition as claimed in claim 1 to 15 comprising a component (A) comprising:
(i) epoxy resin;
(ii) a silane;
(iv) a glycol ether solvent; and
(v) microspheres;
and a component (B) comprising at least one curing agent.

17. A metal substrate having coated thereon a primer coating composition as claimed in any of claims 1 to 15.

18. Use of a primer coating composition as claimed in any of claims 1 to 15 for application to a wet and/or rusted substrate.

19. A method for painting on a wet metal substrate comprising
1) blending component A and component B;
wherein component (A) comprises an epoxy resin; and
component (B) comprising a curing agent; and wherein at least one of components (A) or (B) comprises a silane; a glycol ether solvent and microspheres such that when components (A) and (B) are combined, the resulting composition comprises 2.0 to 15 wt % of the silane and 1.0 to 9.0 wt % of the microspheres;
2) applying the composition to a wet substrate and
3) allowing said composition to form a film and cure.
